(19) United States
(12) Patent Application Publication
(10) Pub. No.: US 2024/0235869 A1
(43) Pub. Date: Jul. 11, 2024

(54) SOCIAL MEDIA STREAMING SPACES

(71) Applicant: Meta Platforms, Inc., Menlo Park, CA (US)

(72) Inventor: Meredith Taylor Ellis, San Jose, CA (US)

(21) Appl. No.: 18/065,642

(22) Filed: Dec. 14, 2022

(51) Int. Cl. H04L 12/18; G06F 3/04842; G06F 3/0486

(52) U.S. Cl. CPC H04L 12/1822; G06F 3/04842; G06F 3/0486

(57) ABSTRACT

The disclosed systems and methods may include (1) receiving user input from a first user of a social media platform selecting to invite a second user to co-view a social media feed, (2) in response to receiving the user input, creating a digital conferencing room configured to stream a display of the social media feed, and (3) adding the first and second user to the digital conferencing room. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for social media streaming.

FIG. 2 is a block diagram of an exemplary system for social media streaming.

FIG. 3 is an illustration of an exemplary newsfeed interface.

FIG. 4 is an illustration of an exemplary digital stories feed interface.

FIG. 5 is an illustration of an exemplary messaging thread interface.

FIG. 6 is an illustration of an exemplary short-form video feed interface.

FIGS. 7-9 are illustrations of exemplary interfaces for social media streaming.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to a social media streaming space (e.g., an interface of a media conferencing room) that enables shared social media feed engagement experiences (e.g., enabling users to view and/or interact with a social media feed together in real time via different devices). In some examples, a user may initiate a social media feed co-engagement experience (e.g., a “View with Me” experience) by selecting an initiation element in a social media interface (e.g., a social media feed interface, a content discovery interface, and/or a dedicated co-engagement entry point interface). In some examples, the initiation element may be associated with a particular social media feed. For example, the initiation element may be provided within an interface of a social media feed and may initiate co-engaging with the social media feed. As another example, the initiation element me be provided within a suggested content card corresponding to a suggested social media feed. In these examples, the selection of the initiation element for co-engagement may automatically include a selection of the social media feed associated with the initiation element. Additionally or alternatively, the initiation element may be associated with a particular additional user for co-engaging. In these examples, the selection of the initiation element may automatically include a selection of the particular additional user for co-engaging.

In some examples, selection of the initiation element may initiate an initiation flow (e.g., may surface one or more interfaces for initiating a co-engagement session). The initiation flow may enable and/or require a variety of selections. For example (e.g., in examples in which the initiation element is not associated with a particular social media feed), the initiation flow may enable the selection of a social media feed for co-engagement. As another example, (e.g., in examples in which the initiation element is not associated with a particular additional user for co-engaging), the initiation flow may enable the selection of one or more additional users to invite to join a co-engagement experience. In one such example, providing the initiation flow may include presenting a co-engagement selection sheet that includes a list of selectable entries, each corresponding to a different contact of the initiating user.

Once a co-engagement experience has been established (e.g., a social media feed and one or more additional users for co-engaging have been selected), the disclosed system may create a media feed conferencing room (e.g., a digital group living room) and add the initiating user and one or more additional users (e.g., the additional users that have accepted a co-engagement invitation) to the media feed conferencing room (e.g., by granting the users with access to the media feed conferencing room, providing the users with a media feed conferencing room interface, and/or enabling the users to contribute a user stream to the media feed conferencing room and/or to interact via a group chat provided within the media feed conferencing room).

The disclosed media feed conferencing room may include a variety of features and/or functionalities. For example, the media feed conferencing room may include a display of a social media feed as a base display within a conferencing room interface. The media feed conferencing room may enable participating users to interact with the social media feed such that input to the display of the social media feed (e.g., scrolling input, post selection input, etc.) may create a change in the display of the social media feed that is reflected in the interface presented to each participating user's device.

In some examples, the disclosed media feed conferencing room may enable co-creation between participating users. For example, the media feed conferencing room may enable co-creation of a social media post and/or of a digital response to another post of the social media feed. In some such examples, the media feed conferencing room may enable each of the participating users to digitally contribute to the post and/or response and may reflect each user's contribution in real-time to the devices of each of the other participating users.

As will be explained in greater detail below, embodiments of the present disclosure may improve the field of social networking by improving data streaming, data organization, and data discovery (e.g., by enabling co-viewing of social media feeds). Embodiments of the present disclosure may improve a computer itself by improving data consumption flows and data organization.

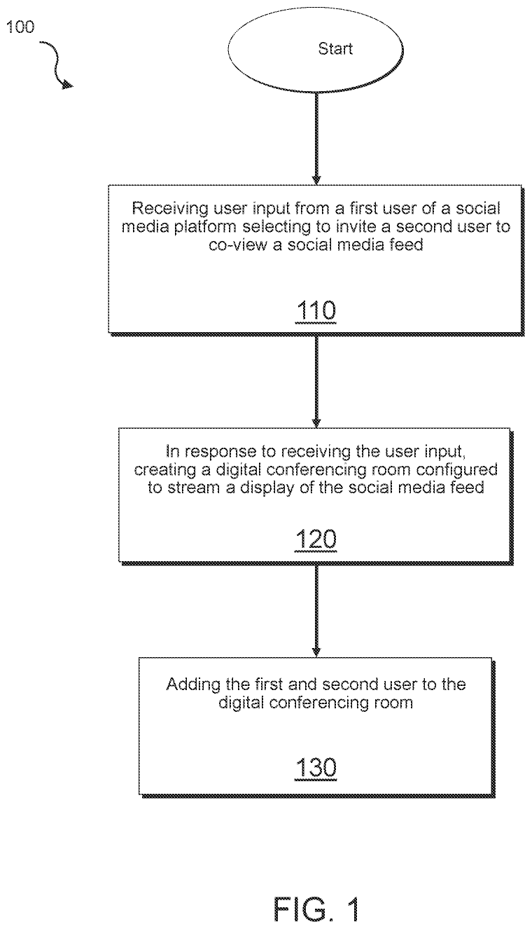

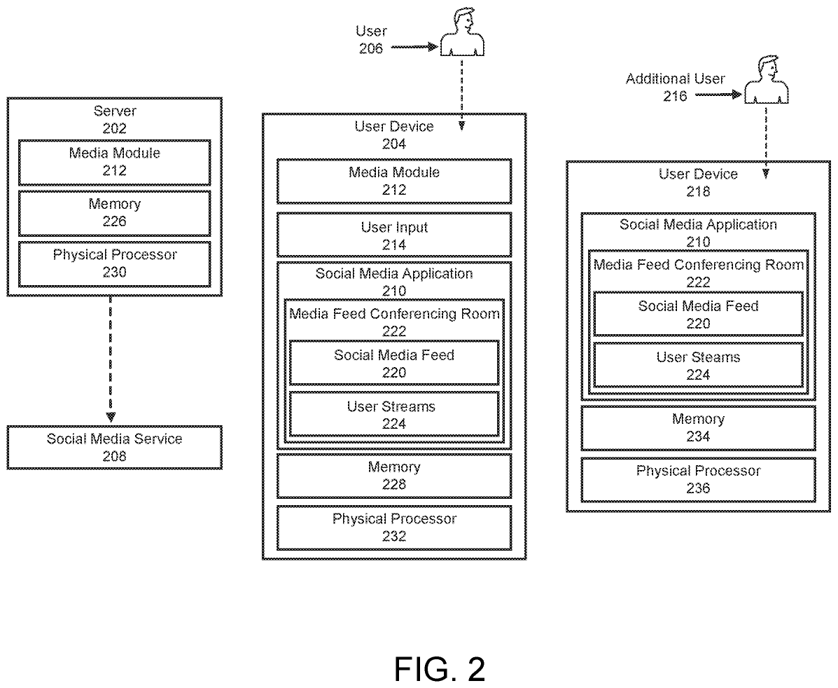

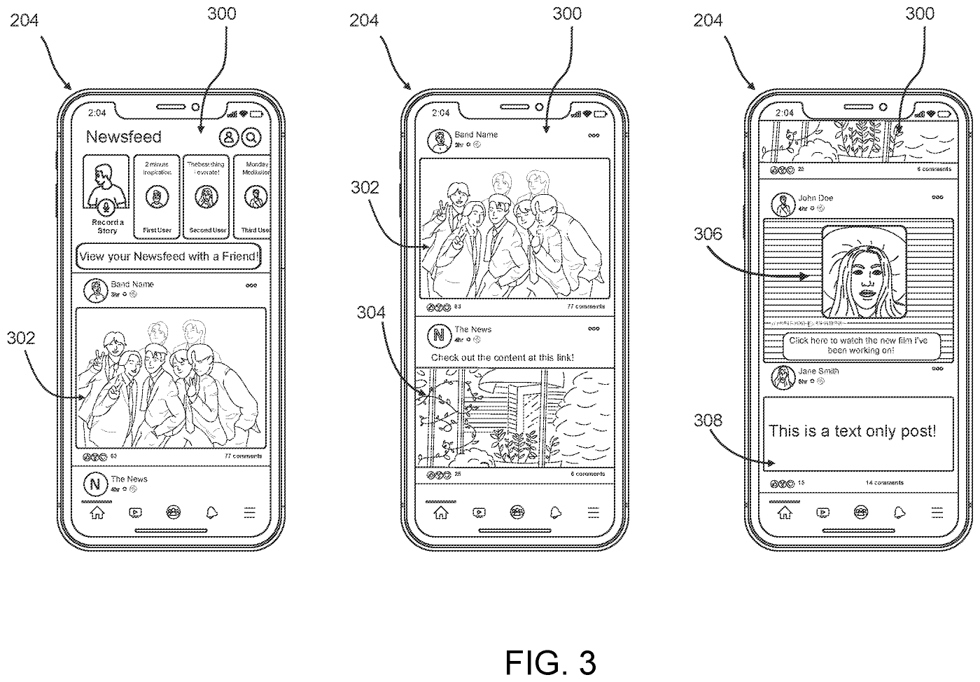

The following will provide, with reference to FIG. 1, detailed descriptions of computer-implemented methods for social media feed streaming. Detailed descriptions of corresponding example systems will also be provided in connection with FIG. 2. Detailed descriptions of interfaces and embodiments corresponding to the disclosed methods and systems will be provided in connection with FIGS. 3-9.

FIG. 1 is a flow diagram of an exemplary computer-implemented method 100 for social media feed streaming. The steps shown in FIG. 1 may be performed by any suitable computer-executable code and/or computing system, including the system(s) illustrated in FIG. 2. For example, the steps shown in FIG. 1 may be performed by modules operating in a server 202 and/or modules operating in a user device 204 (associated with a user 206). In one example, each of the steps shown in FIG. 1 may represent an algorithm whose structure includes and/or is represented by multiple sub-steps, examples of which will be provided in greater detail below.

Server 202 generally represents any type or form of backend computing device that may perform one or more functions directed at social networking. The term “social networking” may refer to any type or form of digital communication that occurs between users of a social networking platform via an interface of the social networking platform. Examples of social networking may include, without limitation, text-based and/or image-based communication, video-based communication, audio-based communication, videoconferencing and/or audioconferencing, digital status broadcasting, private digital messaging, public content posting and/or commenting via a social media feed and/or a profile, etc. In some examples, server 202 may operate as part of and/or in connection with a social media platform 208. Although illustrated as a single entity in FIG. 2, server 202 may include and/or represent a group of multiple servers that operate in conjunction with one another.

User device 204 generally represents any type or form of computing device capable of reading computer-executable instructions. For example, user device 204 may represent a smart phone and/or a tablet. Additional examples of user device 204 may include, without limitation, a laptop, a desktop, a wearable device, a personal digital assistant (PDA), etc.

In some examples, user 206 of user device 204 may be a user (e.g., a member) of a social networking platform (e.g., social media platform 208). In these examples, user device 204 may have installed an instance of a social media application 210, which may operate as part of social media platform 208 and through which one or more services provided by social media platform 208 (e.g., via server 202) may be accessible. In some examples, social media application 210 may be dedicated to a single service. For example, social media application 210 may represent a dedicated social media consumption application (e.g., a dedicated newsfeed application or a dedicated short-form video application). In other examples, social media application 210 may provide access to multiple services (e.g., a combination of two or more of the social networking services described below). In addition, or as an alternative, to social media application 210, user device 204 may have installed a browser that may navigate to one or more webpages through which the one or more services provided by social media platform 208 (e.g., via server 202) may also be accessible.

As mentioned above, social media platform 208 may provide a variety of services (e.g., platforms and/or frameworks) for the users within its network (e.g., via server 202 and/or social media application 210). For example, social media platform 208 may provide a newsfeed service. The term “newsfeed” may generally refer to any type or form of social media consumption channel, provided via an interface, that presents a scrollable collection of newsfeed posts. In some examples, a newsfeed may scroll (e.g., upward or downward) to reveal the different posts within the newsfeed (e.g., in response to receiving user scrolling input). In one example, the scrollable collection may include newsfeed posts created by contacts of a particular user (e.g., friends of the particular user) and/or other users that the particular user is following (i.e., connected content). Additionally, the newsfeed may include non-connected content (e.g., content created by users who are not contacts of the particular user).

The term “newsfeed post” generally refers to any type or form of digital composition that may be displayed in a newsfeed. Newsfeed posts may include a variety of content. For example, a newsfeed post may include, without limitation, text, an image, a video, a set of multiple images and/or videos, and/or a link (e.g., to a post, webpage, article, film, etc.). FIG. 3 depicts an exemplary newsfeed interface 300 with a newsfeed that includes an image-based newsfeed post 302, a link-based newsfeed post 304, a video-based newsfeed post 306, and a text-based newsfeed post 308.

In some examples, a newsfeed post may include a viewing pane for the content of the newsfeed post (e.g., the text in a text-based post, the image in an image-based post, etc.). A newsfeed post may also display a text-based caption, metadata content (e.g., content describing users that have been tagged in the newsfeed post, a timestamp, etc.), information indicating the source of the newsfeed post (e.g., the name of the creator of the post, a profile image, etc.), and/or a digital special effect (e.g., a digital sticker, a filter, an-augmented reality element, etc.). Such information and/or features may be displayed (and/or a menu corresponding to such information and/or features may be displayed) within the viewing pane (e.g., over the primary content), within the viewing pane and/or may be visually associated with the viewing pane (e.g., displayed beneath the viewing pane).

The newsfeed service may enable viewers of a newsfeed post to digitally respond to the newsfeed post in a variety of ways. In some examples, a newsfeed interface may enable a user to comment on a newsfeed post (e.g., via a text, image, and/or video-based reply) and may create a digital thread of comments corresponding to the newsfeed post (e.g., displayed beneath the newsfeed post and/or accessible via a comments affordance).

As another example, social media platform 208 may provide a digital stories service. The digital stories service may provide users with a digital stories feed, which presents a continuous series of digital story posts to a story-consumer, one by one (e.g., in a slideshow format). The term “digital story post” may generally refer to any type or form of digital composition intended for a digital stories feed. A digital story post may include a variety of content (e.g., a digital photograph, a graphic, text, a digital video, an artificial reality element, a digital audio recording, etc.). In one example, the story consumption channel may transition from presenting one digital story post to the next automatically, without requiring any user input to do so. In some examples, digital story posts from the same source (e.g., created and/or posted by the same user) may be grouped together, such that each digital story post from a particular source is displayed prior to displaying digital story posts from another source.

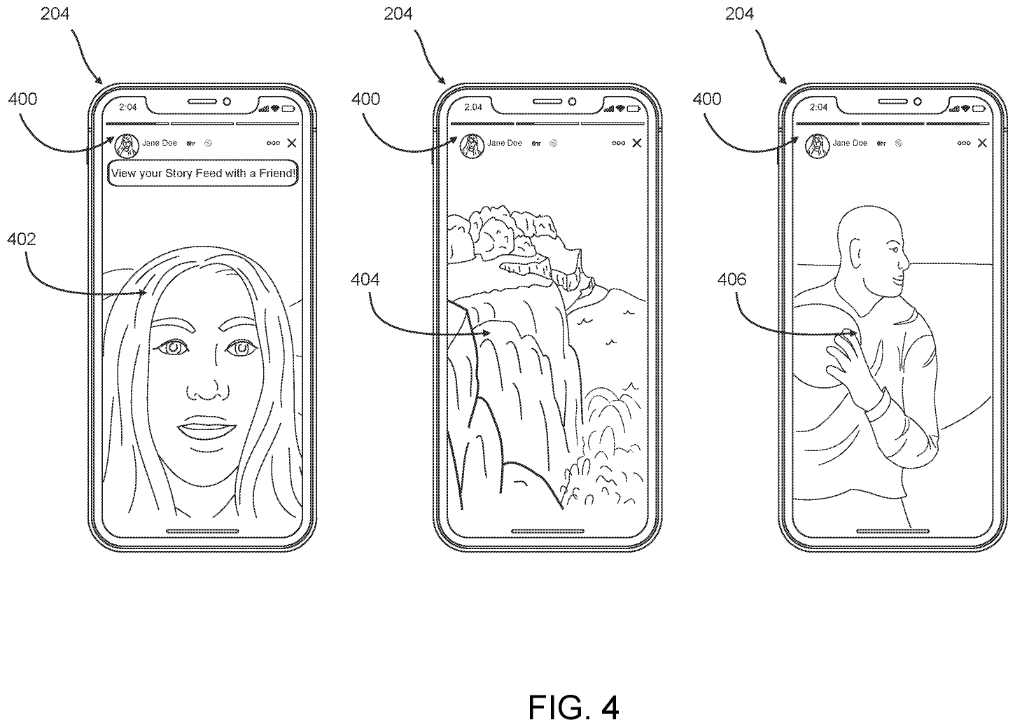

In one embodiment, a digital story post may be ephemeral. That is, the digital story post may only be viewable for a predetermined amount of time. For example, a digital story post may be set to disappear after twenty-four hours. Similar to the newsfeed service, the digital stories service may enable viewers of a story post to comment on the post, via a text and/or image-based reply and/or reply story, creating a digital thread of comments. Also similar to the newsfeed service, the digital stories service may configure a story feed for a particular user that includes connected content (e.g., story posts created by users who are contacts of the particular user or being followed by the particular user), non-connected content, or a determined ratio of connected content to non-connected content. FIG. 4 depicts an exemplary story interface 400 showing digital story posts 402, 404, and 406 of a user's digital story.

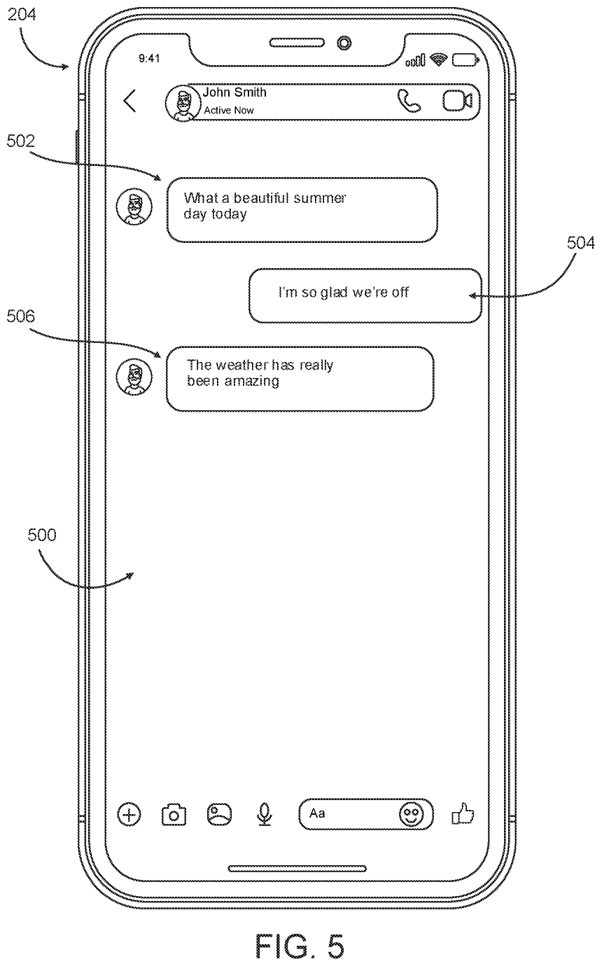

As another example, social media platform 208 may provide a messaging service. The term “messaging service” may generally refer to any type or form of digital message delivery system that enables users of social media platform 208 to exchange messages (e.g., text messages, audio messages, and/or video messages). FIG. 5 depicts an exemplary messaging interface 500 showing digital message posts 502, 504, and 506 of a digital messaging thread.

In some examples, social media platform 208 may provide a short-form video service (e.g., a reels service) that enables users to create short-form videos and/or consume (e.g., watch and/or digitally respond to) short-form videos created by other users. In one embodiment, social media platform 208 may create a short-form video feed for each user of its short-form video service. The term “short-form video” may generally refer to a digital video configured for short-form video feed consumption. In some examples, a platform for creating and/or posting a short-form video may only enable the creation and/or posting of short-form videos that are a certain length and/or that are less than a certain length (e.g., less than thirty seconds in length).

The term “short-form video feed” may generally refer to a series (e.g., a queue) of digital short-form videos (e.g., selected for a particular user) that social media application 210 (or a corresponding webpage) is configured to play, one by one, as a continuous series (e.g., advancing from one short-form video to the next automatically). In some examples, a short-form video feed may be configured to play short-form videos asynchronously (e.g., to play a continuously evolving queue of pre-recorded short-form videos). In some examples, short-form videos may be continuously added to a user's short-form video feed as the short-form videos of the feed are consumed (e.g., such that a determined number of short-form videos are always in queue to be played).

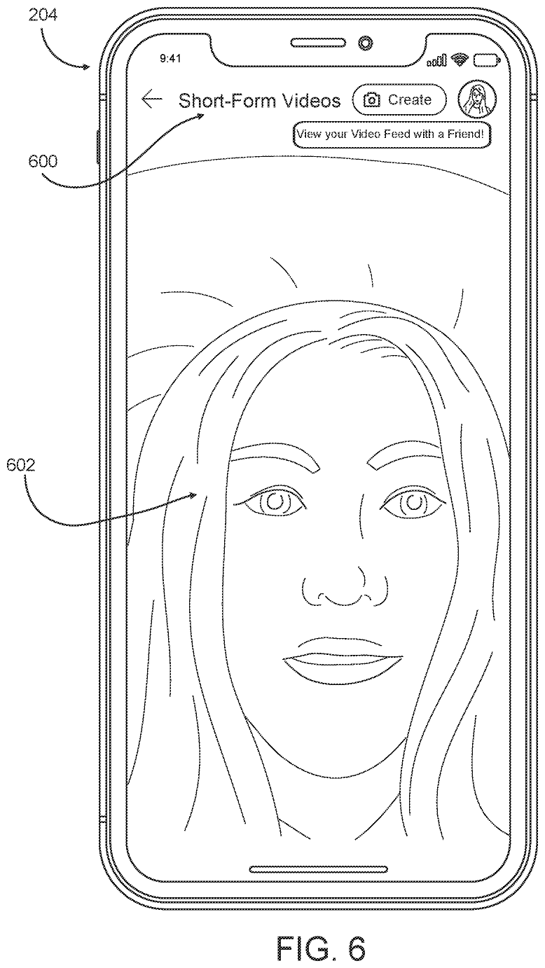

In some examples, a short-form video feed may be presented via a dedicated short-form video feed interface. FIG. 6 depicts an exemplary dedicated short-form video feed interface 600 presenting a short-form video. Short-form videos may be selected for the short-form video feed of a particular user based on a variety of metrics. For example, a short-form video may be selected based on a topic the short-form video has been tagged with (e.g., in response to a determination that the particular user is interested in and/or predicted to be interested in the topic). As another example, a short-form video may be selected based on a user who created the short-form video (e.g., in response to a determination that the particular user is following the user and/or is predicted to be interested in content by the creator). As another example, a short-form video may be selected based on a popularity of the short-form video.

In some embodiments, a short-form video may be displayed (e.g., streamed) with a variety of information relating to the short-form video. Such information may include, for example, a name and/or profile element of an account that created the short-form video, a title of the short-form video, viewer responses to the short-form video and/or an affordance that navigates to viewer responses to the short-form video, one or more elements for providing a digital social response to the short-form video, a transcript of the short-form video, etc.

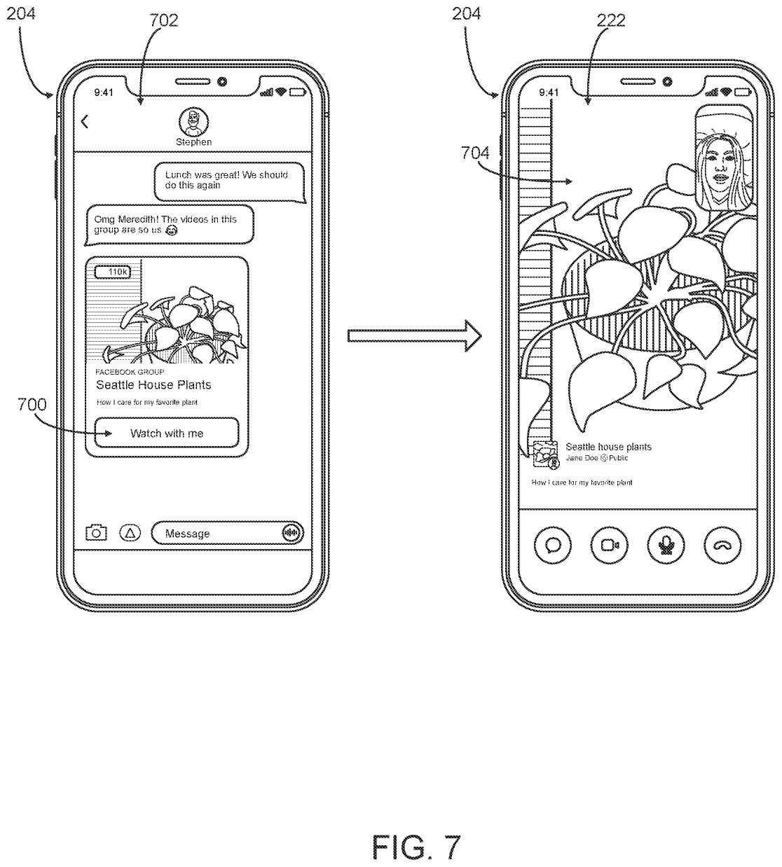

As another example, social media platform 208 may provide a media conferencing (e.g., audioconferencing and/or videoconferencing) service (e.g., a “rooms” service) for hosting media calls (e.g., audio calls and/or video calls). The media conferencing service may operate as a stand-alone service and/or may be integrated with another service (e.g., a messaging service, a social media broadcasting and consumption service, etc.). The term “media conferencing service” refers to any type or form of streaming and/or videotelephony service that enables the digital transmission and/or sharing of real-time media (e.g., video and/or audio) streams (e.g., from multiple endpoints) via a media conferencing interface. The term “real-time media stream” generally refers to any type or form of multimedia that is transmitted in real time (e.g., as a series of frames) from an endpoint (i.e., a transmitting device) to one or more additional endpoints. Audio and/or frames may be played and/or displayed by an endpoint (to a user) as the audio and/or frames are received. FIGS. 7-9 depict exemplary media rooms that enable digital co-viewing of social media feeds, as will be described in greater detail below in connection with steps 110-130.

Returning to FIG. 1, at step 110, one or more of the systems described herein may receiving user input from a first user of a social media platform selecting to invite a second user to co-view a social media feed. For example, as illustrated in FIG. 2, a media module 212 may receive user input 214 from user 206 of social media platform 208 selecting to invite additional user 216 of social media platform 208 (e.g., a user who accesses one or more services of social media platform 208 via an instance of social media application 210 installed on a user device 218 of additional user 216) to co-view a social media feed 220.

Media module 212 may receive user input 214 in a variety of ways. In examples in which media module 212 operates within user device 204 (e.g., as part of social media application 210), media module 212 may receive user input 214 directly (e.g., as tapping input to a touchscreen of user device 204 and/or input to an auxiliary device such as a digital mouse and/or a keyboard communicatively coupled to user device 204). In examples in which media module 212 operates within server 202, media module 212 may receive user input 214 by receiving an indication of the user input (e.g., from user device 204).

Media module 212 may receive user input 214 in a variety of contexts. In some examples, a social media interface (e.g., a social media consumption interface) presented via a display element of user device 204 (e.g., by social media application 210) may include a co-viewing initiation element (e.g., an “invite-other-user” element) and media module 212 may receive user input 214 selecting the co-viewing initiation element. In some examples, this social media interface may include and/or represent social media feed 220 and the co-viewing initiation element may invite user 206 to share the social media feed that the user is presently viewing (e.g., with text such as “View This Social Media Feed with a Friend!”)

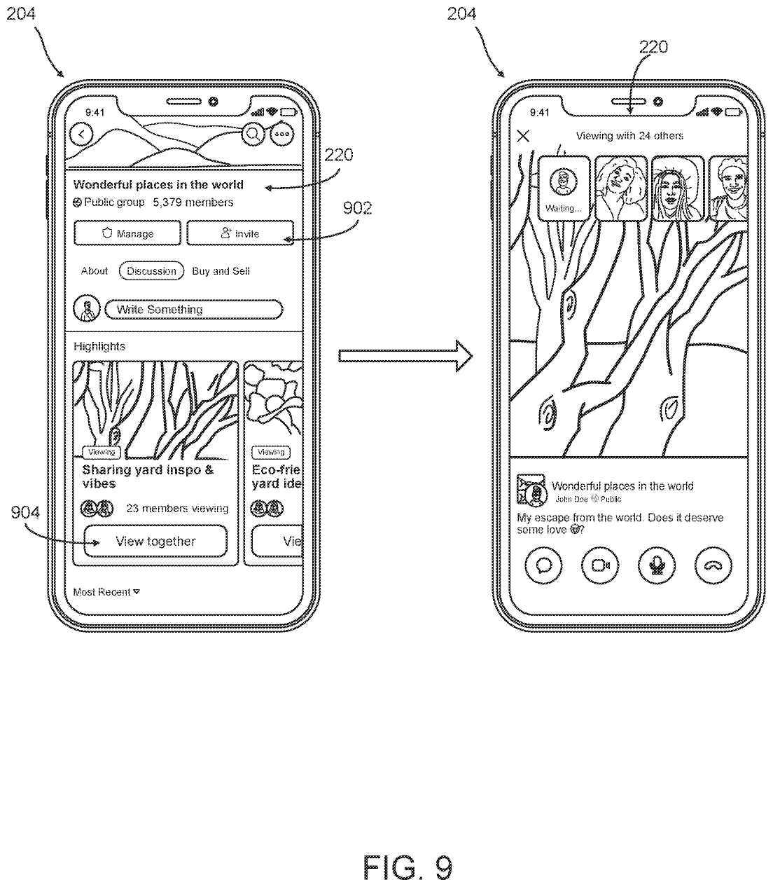

In other examples, the social media interface may represent a content discovery interface that suggests a variety of content for viewing, including social media feed 220, and the co-viewing initiation element may be presented in connection with a suggestion to view social media feed 220. In some such examples, social media feed 220 may relate to a particular topic and may be presented (e.g., within a suggested content card) as a suggested feed for user 206 in visual association with the co-viewing initiation element. FIG. 9 depicts a specific example in which social media feed 220 represents a feed associated with the topic “Wonderful Places in the World.” In FIG. 9, user 206 may select to view social media feed 220 alone or may select element 902 to initiate co-viewing social media feed 220 with an additional viewer.

In other examples, the social media interface may represent a co-viewing launch screen (e.g., dedicated to initiating co-viewing experiences) that enables a user to initiate a social media feed co-viewing experience. In these examples, the co-viewing launch screen may enable user 206 to select a social media interface as part of a co-viewing initiation process.

In each of the contexts just described the social media interface (and/or an interface surfaced in response to user input selecting a co-viewing initiation element) may enable user 206 to select one or more additional users with whom to co-view (e.g., by providing a co-viewer selection sheet with a selectable list of user 206's contacts). In these examples, user input 214 may additionally select additional user 216 (e.g., from the co-viewer selection sheet).

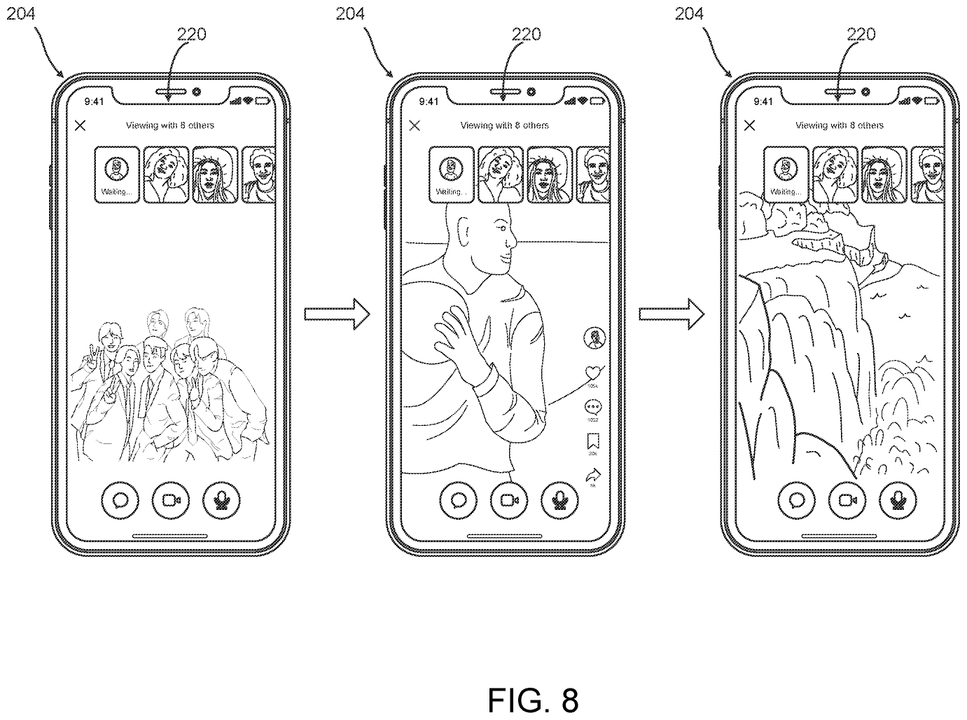

Social media feed 220 may generally represent any type or form of collection of social media content (e.g., social media posts). In some examples, the social media feed may be vertically and/or horizontally scrollable. Multiple posts may be displayed within one display and/or posts may be displayed one at a time. Examples of a social media feed may include, without limitation, a newsfeed, a stories feed, and/or a short-form video feed. In some examples, social media feed 220 may represent a personal feed configured for user 206 (e.g., user 206's personal newsfeed). FIG. 8 presents an embodiment in which social media feed 220 represents a personal feed configured for user 206. Additionally or alternatively, social media feed 220 may represent a curated collection of posts corresponding to a particular topic. For example, FIGS. 7 and 9 present embodiments in which social media feed 220 represents a platform-recommended feed of posts relating to particular topic (e.g., house plants in FIG. 7 and travel inspiration in FIG. 9). In some examples, media module 212 may generate social media feed 220 after receiving user input 214 (e.g., in response to receiving user input 214). For example, media module 212 may create a joint social media feed configured for both user 206 and additional user 216 in response to receiving user input from user 206 requesting to co-view and selecting additional user 216. A joint social media feed may include a variety of content (e.g., content selected based on an overlapping interest between the users, overlapping contacts, overlapping permissions, etc.).

Returning to FIG. 1, at step 120, one or more of the systems described herein may, in response to receiving the user input, create a digital conferencing room configured to stream a display of the social media feed. For example, as illustrated in FIG. 2, media module 212 may, in response to receiving user input 214, create a media feed conferencing room 222 configured to stream a display of social media feed 220. Then, at step 130, one or more of the systems described herein may add the first and second user to the digital conferencing room. For example, as illustrated in FIG. 2, media module 212 may add user 206 and additional user 216 to media feed conferencing room 222.

Media feed conferencing room 222 generally represents any type or form of digital streaming space for a feed-share media call (e.g., a media conferencing session) that enables the digital transmission and/or sharing of a display of a social media feed (e.g., social media feed 220) to multiple endpoints (e.g., to user device 204 and additional user device 218). In some examples, media conferencing room 222 may additionally provide a digital chat feature and/or enable the digital transmission and/or sharing of real-time user media streams 224 (e.g., video streams and/or audio streams of user 206 and additional user 216). These real-time user media streams may originate from multiple endpoints. For example, user 206 may have a user stream (e.g., of video and/or audio captured via a camera and/or microphone of user device 204) that originates from user device 204 and additional user 216 may have a user stream (e.g., of video and/or audio captured via a camera and/or microphone of user device 218) that originates from user device 218.

The term “real-time media stream” generally refers to any type or form of multimedia that is transmitted in real time (e.g., as a series of frames) from an endpoint (i.e., a transmitting device) to one or more additional endpoints. Audio and/or frames may be played and/or displayed by an endpoint (to a user) as the audio and/or frames are received. In some examples, an image and/or video corresponding to a real-time media stream may be displayed within a user tile presented within media conferencing room 222. Media conferencing room 222 may transmit the display of social media feed 220 as a real-time media stream and/or the user media streams as real-time media streams.

In some examples, media conferencing room 222 may include and/or refer to an interface (e.g., a set of one or more interfaces) and creating media feed conferencing room 222 may include configuring the interface. In these examples, an instance of the interface may be presented to an endpoint device of each user participating in a feed-share media call hosted by media conferencing room 222 (e.g., to user device 204 and additional user device 218). The interface may provide a display of social media feed 220 that is synced across each participating endpoint (e.g., such that each endpoint device is being presented with a same view of social media feed 220 and/or the same content of social media feed 220 at substantially the same time). Additionally, the interface may present user tiles for the user streams of participating users.

Media conferencing room 222 may be configured according to a variety of user-selected privacy settings. For example, media conferencing room 222 may be configured as a public room (e.g., which any user of social media platform 208 may join) or a private room (e.g., which requires an invitation to join and/or that only a contact of user 206 may be permitted to join). In some examples, media conferencing room 222 may be capped at any designated number of participants. In other examples, media conferencing room 222 may have no participant cap (i.e., may allow any number of participants to be added to the room).

Media feed conferencing room 222 may be presented in any visual configuration. In some examples, media feed conferencing room 222 may display social media feed 220 as a base display (e.g., a full-screen display within an interface of media conferencing room 222). In these examples, user streams (e.g., of user 206 and additional user 216) may be presented in tiles that overlay the base display. The user stream tiles may overlay the base image of the social media feed 220 in a variety of ways. In one example, user stream tiles may be shown in a scrollable carousel along the top of the base image (e.g., as depicted in FIGS. 8-9). In another example, a user stream tile may be shown in a corner (e.g., as depicted in FIG. 7).

In addition to social media feed 220 and/or (in some examples) user streams for user 206 and/or additional user 216, media feed conferencing room 222 may include a variety of additional information. Such information may include a name of each user added to (e.g., participating in) media conferencing room 222, a number of users added to (e.g., participating in) media conferencing room 222, a chat feature (e.g., that enables text-based exchange between the participants of media conferencing room 222), elements for upgrading to video and/or downgrading to audio-only, an element for muting a participant, an element for leaving media feed conferencing room 222, etc.

User 206 and additional user 216 may be added to media conferencing room 222 in a variety of ways. In some examples, media module 212 may add a user by transmitting an interface corresponding to media conferencing room 222 to the user's device (e.g., via an instance of social media application 210). Additionally, media module 212 may add a user by enabling the user to capture a user stream (e.g., via a microphone and/or camera as instructed by social media application 210) and/or by streaming the user's user stream within an interface corresponding to media conferencing room 222.

Media module 212 may add user 206 and additional user 216 in response to a variety of triggers. In some examples, media module 212 may add user 206 in response to receiving user input 214 from user 206. Additionally or alternatively, media module 212 may add user 206 and/or additional user 216 in response to receiving user input from additional user 216 accepting an invitation to join media conferencing room 222 (i.e., the invitation initiated by user input 214). FIG. 7 depicts an embodiment in which user input 214 triggers an invitation with link 700 to be transmitted to additional user 216 via a post of a messaging thread 702. In these examples, additional user 216 (and/or both user 206 and additional user 216) may be added to media conferencing room 222 in response to media module 212 receiving user input to additional user device 218 selecting link 700.

Once the users have been added to media conferencing room 222, the social media feed content presented within media conferencing room 222 may change based on user interaction with media conferencing room 222. In some examples, media module 212 may modify a view of social media feed 220 within media conferencing room 222 based on user input to social media feed 220 received via media conferencing room 222. For example, media module 212 may receive user input to social media feed 220 to change a post or posts being displayed within social media feed 220 and may change the post being displayed as directed by the user input. As a specific example, media module 212 may receive scrolling input to social media feed 220 via media conferencing room 222 and may scroll social media feed 220 in a direction indicated by the user scrolling input. As another specific example, media module 212 may receive tapping input that may trigger a change in the display. Additionally or alternatively, media module 212 may receive user input to surface a full-screen view of a post from a preview view provided within social media feed 220.

In some embodiments, media module 212 may receive user input to media conferencing room 222 to submit digital feedback (e.g., to leave a comment and/or select and post an emoji) for a post within social media feed 220. In these examples, media module 212 may show the digital feedback being created and/or added to the post in the display of social media feed 220 within media conferencing room 222 to each participating endpoint.

In some examples, media module 212 may enable each user participating in media conferencing room 222 (e.g., user 206 and additional user 216) to interact with social media feed 220 (e.g., to scroll, select posts for display, leave feedback, change to a different social media for co-viewing, etc.). In other examples, only the initiator user who initiated the co-viewing streaming session (e.g., user 206), and/or a user who was given digital permission by the initiator user, may be enabled to interact with social media feed 220.

In some examples, media module 212 may enable the creation of social media content based on inputs received from both the first user's device and the second user's device to the media feed conferencing room. For example, media module 212 may receive a user selection (e.g., from user 206 and/or additional user 216 to user device 204 and/or additional user device 218) of a post-creation element, presented within the display of social media feed 220 within media feed conferencing room 222, that triggers a post creation process. In response, media module 212 may present, within media feed conferencing room 222, a creation interface (e.g., a set of creation interfaces) that enable the users to submit text, capture and/or upload photographs, images, and/or video, add digital stickers, tag a post with contacts, etc. In some examples, media feed conferencing room 222 may enable each of the users participating in the conferencing room to participate in the creation process (e.g., to submit user input to the creation interface). Media feed conferencing room 222 may enable both users to submit user input at substantially the same time or may only enable one user to submit user input at a time.

As another example, media module 212 may receive a user selection (e.g., from user 206 and/or additional user 216 to user device 204 and/or additional user device 218) of a post-feedback element, presented within the display of social media feed 220 within media feed conferencing room 222 in associated with a post, that triggers a co-participant post-feedback creation process (e.g., to leave a comment to the post and/or select an emoji to post to the post). In response, media module 212 may enable post-feedback (e.g., text, emoji-selection, image-capturing and/or uploading, etc.) to be created and/or selected within media feed conferencing room. Media feed conferencing room 222 may enable both users to submit user feedback input at substantially the same time or may only enable one user to submit user feedback input at a time.

In some examples, media module 212 may (1) determine that user 206 has navigated from social media feed 220 to an additional social media feed and, in response, may (2) present the additional social media feed within media conferencing room 222 (e.g., as a base display within media conferencing room 222). In some examples, the additional social media feed may represent an additional social media feed maintained by social media platform 208. In other examples, the additional social media feed may represent a social media feed maintained by an additional social media platform. In these examples, the disclosed social media feed streaming framework may represent a cross-platform framework that enables co-viewing of social media feeds across platforms.

In some examples, media module 212 may generate and provide a reactive social media feed via media conferencing room 222. In such examples, a machine learning system may select content for the reactive feed based on a variety of factors (e.g., a category of a group of users participating in media conferencing room 222, an interest of the primary user who initiated media conferencing room 222, a combined interest of two or more of the participating users, search parameters provided by the participating users to a search feature such as a hashtag prompt, etc.).

In certain embodiments, once media conferencing room 222 has been established (e.g., as a live media conferencing room), the disclosed systems may generate a suggestion that an additional user (e.g., a third user) join media feed conferencing room 222 (e.g., in accordance with a privacy setting selected by user 206 for media feed conferencing room 222). FIG. 9 depicts an example in which a suggested co-viewing feed card 904 is presented within a content discovery interface. Card 904 may correspond to a co-viewing feed room with active user participation (e.g., a live media feed conferencing room) that user 206 has permission to join. In response to receiving user input from the third user (e.g., to card 904), media module 212 may add the third user to media feed conferencing room 222 (e.g., as depicted in FIG. 9).

In some examples, media module 212 may create media feed conferencing room 222, add user 206 to media feed conferencing room 222, and/or add additional user 216 to media conferencing room 222 in response to receiving only user input 214 (e.g., prior to receiving user input from additional user 216 accepting the invitation from user 206 to join media feed conferencing room 222). In other examples, media module 212 may create media feed conferencing room 222, add user 206, and/or add additional user 216 in response to both receiving user input 214 and receiving user input from additional user 216 accepting the invitation from user 206. In some examples, media module 212 may add a user to media feed conferencing room 222 by providing permission for the user to access media feed conferencing room 222 (e.g., enabling access to a streaming interface corresponding to media feed conferencing room 222). Additionally or alternatively, media module 212 may add a user to media feed conferencing room 222 by enabling the user to access media feed conferencing room 222 (e.g., by transmitting and/or presenting the streaming interface corresponding to media feed conferencing room 222 via the user's device) and/or by enabling the user to contribute a user stream to the streaming interface.

As described above, the disclosed systems and methods provide a co-engagement framework (e.g., a “Groups Living Room” framework) that enables a social media co-engagement experience for users. The co-engagement framework may empower each user in a group of users to engage independently with shared content (e.g., a shared social media feed) in real-time, with each user in the group accessing their own user interface to comment, react to, and/or share content and to prompt conversation. The co-engagement framework may enable co-engagement of any type or form of content and/or service (e.g., product) provided by a social media platform (e.g., social media posts, social media stories, music, photos, etc.).

User interfaces corresponding to the methods and systems described above may be surfaced as part of a variety of navigational flows (e.g., a variety of content discovery flows and/or a variety of social media feed consumption flows). In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

Each of the computer-mediated actions described herein may be performed by a module (e.g., media module 212) that operates within an endpoint device (e.g., user device 204 and/or user device 218) and/or that operates within a backend server (e.g., server 202). In the examples in which an action involves presenting digital content to a user via an endpoint device and/or receiving user input and/or digital feedback from the user to the endpoint device, a module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server). In examples in which a module performs an action indirectly, the module may perform the action in a variety of ways. For example, the module may perform the action by instructing the endpoint device to perform the action, by transmitting content to the endpoint device to be presented by the endpoint device, by providing the endpoint with an application (e.g., social media application 210) that performs the action, by receiving an indication of user input to the endpoint device from the endpoint device, etc. Additionally, in some examples, the module may perform the actions described herein operating in a combination of an endpoint device and a backend server.

In some of the embodiments described above, a module (e.g., media module 212) may select content for user 206. For example, a module may select social media consumption content for user 206 (e.g., a social media composition for a social media feed and/or a social media feed relating to a particular topic or theme) and/or suggested additional users for user 206 (e.g., users with whom to co-view a social media feed, a digital group to join, etc.). In these embodiments, the module may select content for user 206 in a variety of ways. For example, social media consumption content may be selected based on a relationship between user 206 and a creator of the social media consumption content (e.g., in response to determining that the creator is a contact of user 206 and/or that user 206 is following the creator), a user history and/or demographic of user 206 (e.g., indicative of a user interest), user data relating to a contact of user 206 and/or additional users with a feature in common with user 206 (e.g., data indicating that such users viewed and/or reacted to certain content), etc. As another example, an additional user may be selected for user 206 based on a relationship between user 206 and the additional user (e.g., a relationship claimed by user 206 within social media platform 208, a number of social connections between user 206 and the additional user such as a number of mutual contacts, and/or a metric relating to an amount of digital interaction between user 206 and the additional user within social media platform 208).

In some examples, content may be selected for user 206 by a machine learning system (e.g., a neural network). In these examples, the machine learning system may select the content in response to receiving a variety of inputs. Such inputs may include inputs relating to user 206 (e.g., an input derived from a user history, an expressed user preference, etc.), inputs relating to users with a features in common with user 206, inputs relating to a demographic and/or a region associated with user 206, inputs derived from a social graph, inputs relating to potential content that may be selected for user 206 (e.g., a topic of such content and/or a popularity of such content), etc.

### Example Embodiments

Example 1: A computer-implemented method may include (1) receiving user input from a first user of a social media platform selecting to invite a second user to co-view a social media feed, (2) in response to receiving the user input, creating a digital conferencing room configured to stream a display of the social media feed, and (3) adding the first and second user to the digital conferencing room.

Example 2: The computer-implemented method of example 1, where adding the first and second user to the digital conferencing room includes (1) transmitting a first instance of a streaming interface corresponding to the digital conferencing room to a device of the first user and (2) transmitting a second instance of the streaming interface to a device of a second user.

Example 3: The computer-implemented method of examples 1-2, where the digital conferencing room is further configured to stream a user stream corresponding to the first user and/or a user stream corresponding to the second user.

Example 4: The computer-implemented method of examples 1-3, where the social media feed includes a short-form video feed, a stories feed, and/or a newsfeed.

Example 5: The computer-implemented method examples 1-4, where the method further includes, after adding the first and second user to the digital conferencing room, (1) receiving user navigation input, to a streaming interface of the digital conferencing room, to navigate from the social media feed to an additional social media feed and (2) in response to receiving the user navigation input, presenting a display of the additional social media feed within the digital conferencing room in place of the display of the social media feed.

Example 6: The computer-implemented method of example 5, where the additional social media feed is hosted by an additional social media platform.

Example 7: The computer-implemented method of examples 1-6, where the method further includes modifying the display of the social media feed within the digital conferencing room based on user input to the social media feed received via a streaming interface of the digital conferencing room.

Example 8: The computer-implemented method of example 7, where the user input to the social media feed, received via the streaming interface, includes user scrolling input modifying the display of the social media feed includes scrolling the social media feed in a direction indicated by the user scrolling input.

Example 9: The computer-implemented method of examples 7-8, where the user input to the social media feed, received via the streaming interface, includes user input received via a device of the first user and/or a device of the second user.

Example 10: The computer-implemented method of examples 1-9, where the method further includes enabling the creation of social media content via the digital conferencing room based on user input to a streaming interface of the digital conferencing room received via a device of the first user, a device of the second user, or both the device of the first user and/or the device of the second user.

Example 11: The computer-implemented method of example 10, where the social media content includes a social media post the computer-implemented method further includes receiving user posting input to the streaming interface of the digital conferencing room and posting the social media post to the social media feed in response to receiving the user posting input.

Example 12: The computer-implemented method of examples 10-11, where the social media content includes digital feedback to a social media post of the social media feed and the computer-implemented method further includes receiving user posting input to the streaming interface of the digital conferencing room and posting the digital feedback to the social media post of the social media feed in response to receiving the user posting input.

Example 13: The computer-implemented method of example 12, where the digital feedback includes an emoji and/or a digital comment that includes text, an image, a video, and/or a digital sticker.

Example 14: The computer-implemented method of examples 1-13, where the social media feed includes a feed of content relating to a particular topic and receiving the user input selecting to invite the second user to co-view the social media feed includes (1) prior to receiving the user input, presenting, within a social media consumption interface, a suggested content card configured to surface the social media feed, relating to the particular topic, when selected via user input, (2) providing a co-viewing initiation element within the suggested content card, (3) receiving user input from the first user selecting the co-viewing initiation element, (4) in response to receiving the user input selecting the co-viewing initiation element, presenting a co-viewer selection sheet, and (5) receiving user input from the user to the co-viewer selection sheet selecting the second user for co-viewing.

Example 15: The computer-implemented method of example 14, where the method further includes, after creating the digital conferencing room providing, within an additional social media consumption interface presented to a third user via a display element of a device of the third user, an additional instance of the suggested content card, indicating, within the additional instance of the suggested content card, that the first and second user are currently co-viewing the social media feed, relating to the particular topic, via the digital conferencing room, and enabling the third user to join the digital conferencing room via the additional instance of the suggested content card.

Example 16: The computer-implemented method of example 15, where the method further includes adding the third user to the digital conferencing room in response to receiving user input to the additional instance of the suggested content card selecting to join the digital conferencing room.

Example 17: A system for implementing the above-described method may include at least one physical processor and physical memory that includes computer-executable instructions that, when executed by the physical processor, cause the physical processor to (1) receive user input from a first user of a social media platform selecting to invite a second user to co-view a social media feed, (2) in response to receiving the user input, create a digital conferencing room configured to stream a display of the social media feed, and (3) add the first and second user to the digital conferencing room.

Example 18: The system of example 17, where adding the first and second user to the digital conferencing room includes (1) transmitting a first instance of a streaming interface corresponding to the digital conferencing room to a device of the first user and (2) transmitting a second instance of the streaming interface to a device of a second user.

Example 19: The system of examples 17-18, where the digital conferencing room is further configured to stream a user stream corresponding to the first user and/or a user stream corresponding to the second user.

Example 20: A non-transitory computer-readable medium may include one or more computer-readable instructions that, when executed by at least one processor of a computing device, cause the computing device to (1) receive user input from a first user of a social media platform selecting to invite a second user to co-view a social media feed, (2) in response to receiving the user input, create a digital conferencing room configured to stream a display of the social media feed, and (3) add the first and second user to the digital conferencing room.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory devices 226, 228, and 234 in FIG. 2) and at least one physical processor (e.g., physical processors 230, 232, and 236 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving user input from a first user of a social media platform selecting to invite a second user to co-view a social media feed;
in response to receiving the user input, creating a digital conferencing room configured to stream a display of the social media feed; and
adding the first and second user to the digital conferencing room.

2. The computer-implemented method of claim 1, wherein adding the first and second user to the digital conferencing room comprises:
transmitting a first instance of a streaming interface corresponding to the digital conferencing room to a device of the first user; and
transmitting a second instance of the streaming interface to a device of a second user.

3. The computer-implemented method of claim 1, wherein the digital conferencing room is further configured to stream at least one of a user stream corresponding to the first user or a user stream corresponding to the second user.

4. The computer-implemented method of claim 1, wherein the social media feed comprises at least one of a short-form video feed, a stories feed, or a newsfeed.

5. The computer-implemented method of claim 1, further comprising, after adding the first and second user to the digital conferencing room:
receiving user navigation input, to a streaming interface of the digital conferencing room, to navigate from the social media feed to an additional social media feed; and
in response to receiving the user navigation input, presenting a display of the additional social media feed within the digital conferencing room in place of the display of the social media feed.

6. The computer-implemented method of claim 5, wherein the additional social media feed is hosted by an additional social media platform.

7. The computer-implemented method of claim 1, further comprising modifying the display of the social media feed within the digital conferencing room based on user input to the social media feed received via a streaming interface of the digital conferencing room.

8. The computer-implemented method of claim 7, wherein:
the user input to the social media feed, received via the streaming interface, comprises user scrolling input; and
modifying the display of the social media feed comprises scrolling the social media feed in a direction indicated by the user scrolling input.

9. The computer-implemented method of claim 7, wherein the user input to the social media feed, received via the streaming interface, comprises user input received via at least one of a device of the first user or a device of the second user.

10. The computer-implemented method of claim 1, further comprising enabling the creation of social media content via the digital conferencing room based on user input to a streaming interface of the digital conferencing room received via at least one of a device of the first user, a device of the second user, or both the device of the first user and the device of the second user.

11. The computer-implemented method of claim 10, wherein:
the social media content comprises a social media post; and
the computer-implemented method further comprises:
receiving user posting input to the streaming interface of the digital conferencing room; and
posting the social media post to the social media feed in response to receiving the user posting input.

12. The computer-implemented method of claim 10, wherein:
the social media content comprises digital feedback to a social media post of the social media feed; and
the computer-implemented method further comprises:
receiving user posting input to the streaming interface of the digital conferencing room; and
posting the digital feedback to the social media post of the social media feed in response to receiving the user posting input.

13. The computer-implemented method of claim 12, wherein the digital feedback comprises at least one of:
an emoji; or
a digital comment comprising at least one of text, an image, a video, or a digital sticker.

14. The computer-implemented method of claim 1, wherein:
the social media feed comprises a feed of content relating to a particular topic;
receiving the user input selecting to invite the second user to co-view the social media feed comprises:
prior to receiving the user input, presenting, within a social media consumption interface, a suggested content card configured to surface the social media feed, relating to the particular topic, when selected via user input;
providing a co-viewing initiation element within the suggested content card;
receiving user input from the first user selecting the co-viewing initiation element;
in response to receiving the user input selecting the co-viewing initiation element, presenting a co-viewer selection sheet; and
receiving user input from the user to the co-viewer selection sheet selecting the second user for co-viewing.

15. The computer-implemented method of claim 14, further comprising, after creating the digital conferencing room:
providing, within an additional social media consumption interface presented to a third user via a display element of a device of the third user, an additional instance of the suggested content card;
indicating, within the additional instance of the suggested content card, that the first and second user are currently co-viewing the social media feed, relating to the particular topic, via the digital conferencing room; and
enabling the third user to join the digital conferencing room via the additional instance of the suggested content card.

16. The computer-implemented method of claim 15, further comprising adding the third user to the digital conferencing room in response to receiving user input to the additional instance of the suggested content card selecting to join the digital conferencing room.

17. A system comprising:
at least one physical processor; and
physical memory comprising computer-executable instructions that, when executed by the physical processor, cause the physical processor to:
receive user input from a first user of a social media platform selecting to invite a second user to co-view a social media feed;
in response to receiving the user input, create a digital conferencing room configured to stream a display of the social media feed; and
add the first and second user to the digital conferencing room.

18. The system of claim 17, wherein adding the first and second user to the digital conferencing room comprises:
transmitting a first instance of a streaming interface corresponding to the digital conferencing room to a device of the first user; and
transmitting a second instance of the streaming interface to a device of a second user.

19. The system of claim 17, wherein the digital conferencing room is further configured to stream at least one of a user stream corresponding to the first user or a user stream corresponding to the second user.

20. A non-transitory computer-readable medium comprising one or more computer-readable instructions that, when executed by at least one processor of a computing device, cause the computing device to:
receive user input from a first user of a social media platform selecting to invite a second user to co-view a social media feed;
in response to receiving the user input, create a digital conferencing room configured to stream a display of the social media feed; and
add the first and second user to the digital conferencing room.
